(19) United States
(12) Patent Application Publication
(10) Pub. No.: US 2023/0260310 A1
(43) Pub. Date: Aug. 17, 2023

(54) SYSTEMS AND METHODS FOR PROCESSING DOCUMENTS

(71) Applicant: codeMantra U.S. LLC, Burlington, MA (US)

(72) Inventors: Muralidharan Rangarajan, Tamilnadu (IN); Sanjeev Kalyanaraman, Lexington, MA (US); Ian A. Smith, Sisters, OR (US); Ranajit Mitra, West Bengal (IN); Shahid Ul Islam, Jammu and Kashmir (IN)

(21) Appl. No.: 18/109,393

(22) Filed: Feb. 14, 2023

Related U.S. Application Data
(60) Provisional application No. 63/310,203, filed on Feb. 15, 2022.

(51) Int. Cl. G06V 30/414; G06V 30/413; G06F 40/169

(52) U.S. Cl. CPC G06V 30/414; G06V 30/413; G06F 40/169

(57) ABSTRACT

In some embodiments, a system for creating a structured content object comprises a database configured to store unstructured content and a control system configured to segment the unstructured content into a plurality of elements, analyze, via a plurality of models, each of the plurality of elements, wherein each of the models is trained for a different type of content, generate, for each of the plurality of elements, confidence scores, generate, for each of the plurality of elements, bounding boxes, determine, based on the confidence scores for each of the plurality of elements, a type of content, determine a reading order, create, based on the confidence scores, the bounding boxes, and the types of content, tags including (i) the confidence scores, (ii) the bounding boxes, and (iii) the types of content for each element of the plurality of elements, and create, based on the tags, the structured content object.

### TECHNICAL FIELD

This invention relates generally to accessibility systems and, more specifically, accessibility systems for computers.

### BACKGROUND

It is valuable for a document to be able to be processed and read by an electronic device, such as a computer or assistive device. Unfortunately, a document does not inherently include the content necessary, or in the right format, to be processed and read by an electronic device. Documents that have not been prepared to be processed and read by an electronic device can be referred to as unstructured content. Electronic devices can quite effectively process and read documents when they have been appropriately prepared. While systems and processes exist that are capable of preparing a document to be processed and read by an electronic device, they are often designed for a single scenario (e.g., for use with a specific assistive technology, for use with a specific file format, for a specific use, etc.). Accordingly, current systems and processes are not well-suited for preparing unstructured content to be processed and read by electronic devices for a variety of uses. Accordingly, a need exists for improved systems and methods for preparing unstructured content such that it can be easily processed and read by an electronic device.

### BRIEF DESCRIPTION OF THE DRAWINGS

Disclosed herein are embodiments of systems, apparatuses, and methods pertaining to the creation of structured content objects. This description includes drawings, wherein:

FIG. 1 depicts a document 102 including markers 154 of content of the document based on a structured content object;

FIG. 2 is a flow chart depicting example operations for creating structured content objects based on unstructured content.

FIG. 3 is a block diagram of a system 300 for creating structured content objects from unstructured content; and

FIG. 4 is a block diagram of a system 400 that may be used for implementing any of the components, circuits, circuitry, systems, functionality, apparatuses, processes, or devices of the system 300 of FIG. 3, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to creating structured content objects based on unstructured content. In some embodiments, a system for creating a structured content object based on unstructured content comprises a database, wherein the database is configured to store the unstructured content, and a control system communicatively coupled to the database, wherein the control system is configured to segment the unstructured content into a plurality of elements, analyze, via a plurality of models, each of the plurality of elements, wherein each of the models is trained for a different type of content, generate, by each of the plurality of models for each of the plurality of elements, confidence scores, generate, by each of the plurality of models for each of the plurality of elements, bounding boxes, determine, based on the confidence scores for each of the plurality of elements, a type of content, determine, for each of the plurality of elements, a reading order, create, based on the confidence scores for each of each of the plurality of elements, the bounding boxes for each of the plurality of elements, and the types of content for each of the plurality of elements, tags, wherein the tags include (i) the confidence scores, (ii) the bounding boxes, and (iii) the types of content for each element of the plurality of elements, and create, based on the tags, the structured content object.

As previously discussed, it is difficult for electronic devices (e.g., a computer) to process and read digital documents. Current systems rely on data that describes a document for a computer to process and read the document. Many files, for example digital documents, include metadata that describe the document. When a computer attempts to process and read the document, it relies on this data much like a person relies on visual cues (e.g., spacing, indentations, capitalization, white spaces, font size, etc.) to process a document. Due to a computer's reliance on this data describing the document, the computer's ability to accurately process and read the document is dependent upon the quality, and presence, of the data describing the document. Unfortunately, many files include incomplete or insufficient data describing a document for a computer to accurately process and read the digital file. Described herein are systems, methods, and apparatuses that seek to minimize, if not eliminate, the drawbacks of the current technology.

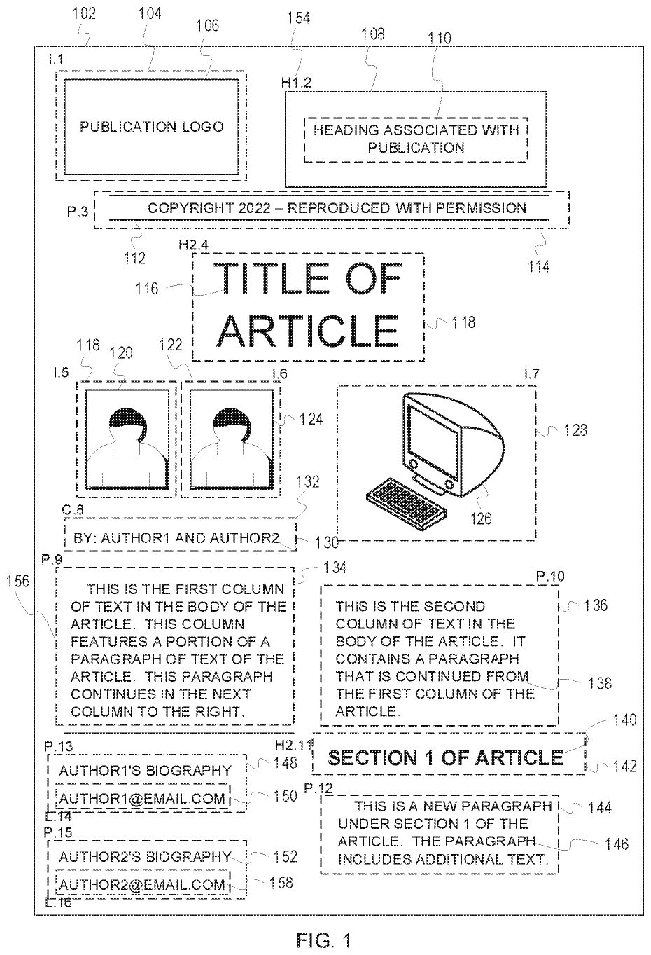

In one embodiment systems, methods, and apparatus process unstructured data (e.g., a document) and generate a structured content object based on the unstructured content. The structured content object includes the document (i.e., the data necessary to reproduce the document) as well as data describing the document such that other systems can process and read the document. In one embodiment, a system processes unstructured content using multiple models. Each of the models is trained for a different type of content (e.g., paragraphs, lists, images, etc.). The system segments the unstructured content into a plurality of elements and each of the models analyzes each element. The models analyze the elements to determine confidence scores and bounding boxes for the elements. The system determines the type of content for each element based on the confidence scores and generates tags for each of the elements. That tags indicate information about the elements that a computer can use to process and read the document. The discussion of FIG. 1 provides an overview of such a system.

FIG. 1 depicts a document 102 including markers 154 of content of the document based on a structured content object. The document 102 depicted in FIG. 1 is an article. The article includes a number of different elements. For example, the article includes a publication logo 106, a heading associated with the publication 108, images, body text, a title 116, etc. The document 102 includes different types of markers 154 that visualize how the content of the document is identified by a structured content object. Accordingly, while visualizations of the markers 154 (and other content indicia such as bounding boxes) may be included in the document 102, such is not required. That is, the markers 154 included in FIG. 1 may not actually be viewable when a user opens a document. Rather, FIG. 1 includes the markers 154 and other content indicia as a visualization of possible content included in tags generated for the document. The markers 154 in FIG. 1 are formatted as [letter][number₁(optional)].[number₂]. The letter (i.e., the first character) indicates the type of the content for the element. The first number (i.e., number₁), if any, indicates a hierarchy level for the occurrence of that type of content. For example, if the first number of a marker is a 1 and the content type of the element associated with the marker is a heading, the element associated with the marker is a heading in the document at the first hierarchy level. As another example, if the first number of a marker is a 2 and the content type of the element associated with the marker is a list, the element associated with the marker is a list in the document at the second hierarchy level. The second number (i.e., number₂) is indicative of the reading order. For example, if the second number of a marker is a 4, the element associated with the marker is the fourth element in the reading order. Elements, content types, and reading orders are discussed in more detail below.

When the document is processed, a system segments the document 102 (i.e., the unstructured data) into elements. Each of the elements is a different section of the document 102. For example, as depicted in FIG. 1, the publication logo 106 has been segmented into an element, the heading associated with the publication 108 has been segmented into an element, images have been segmented into elements, the body text has been segmented into elements, the title 116 has been segmented into an element, etc. The system bounds each of the elements by a bounding box. For example, as depicted in FIG. 1, the publication logo 106 is bounded by a first bounding box 104, the heading associated with the publication 108 is bounded by a second bounding box 110, a copyright notice 112 is bounded by a third bounding box 114, the title 116 is bounded by a fourth bounding box 118, a first author photo 120 is bounded by a fifth bounding box 118, a second author photo 124 is bounded by a sixth bounding box 122, an authorship indicator 130 is bounded by a seventh bounding box 132, a first paragraph 134 is bounded by an eighth bounding box 156, a second paragraph 138 is bounded by a ninth bounding box 136, a section header 140 is bounded by a tenth bounding box 142, a third paragraph 146 is bounded by an eleventh bounding box 144, a first author name is bounded by a twelfth bounding box 148, a first author email address is bounded by a thirteenth bounding box 150, a second author name 152 is bounded by a fourteenth bounding box, a second author email address 158 is bounded by a fifteenth bounding box, and an image 126 is bounded by a sixteenth bounding box 128.

Once segmented, the system analyzes the document 102 via a plurality of models. In one embodiment, each of the models is trained for a different type of content. For example, the models can be trained machine learning models. The content types can include any suitable content type, such as equations, lists, tables, images, paragraphs, headings, links, etc. Though each model is trained for a different content type, in one embodiment, each of the models analyze all of the elements. For example, if the system is utilizing an image model, a paragraph model, and a list model, the image model analyzes all of the elements, the paragraph model analyzes all of the elements, and the list model analyses all of the elements. The models analyze the elements to generate, for example, confidence scores and the bounding boxes. The confidence scores are indicative of the likelihood that an element is indeed a specific content type. For example, if an element is a paragraph, a paragraph model will likely generate a high confidence score for the element, whereas the image model will likely generate a low confidence score for the element.

The system determines a content type for each of the elements based on the confidence scores. Returning to the example in which the system is utilizing the image model, the paragraph model, and the list model, each of the three models will analyze the first paragraph 134 of the document 102. Because the first paragraph 134 of the document 102 is indeed a paragraph (e.g., as opposed to an image or a list), the paragraph model should generate a higher confidence score than the image model and the list model. For example, the paragraph model may generate a confidence score of 95% for the first paragraph 134, while the image model may generate a confidence score of 11% and the list model may generate a confidence score of 57% for the first paragraph 134. Because the paragraph model has generated the highest confidence score for the first paragraph 134, the system determines the first paragraph 134 to have a content type of paragraph. In some embodiments, if one of the confidence scores is above a threshold, it is assumed that that element is of the content type associated with the confidence score that is above the threshold. For example, if one of the models generates a confidence score above a threshold (e.g., 80%, 90%, 95%, etc.) for an element, that element can be assumed to be of that content type. Additionally, in some embodiments, some of the content types can be excluded from consideration based on the confidence scores. For example, if one of the models generates a confidence score below the threshold (e.g., 25%, 40%, 50%, etc.) for an element, that element can be assumed to not be of that content type.

In some embodiments, in addition to, or in lieu of, the confidence scores, the system can utilize rules to determine the types of content for each of the elements. For example, the system can utilize content rules to improve the accuracy of the content type determinations and/or decrease the computational processing necessary for determining the content types. The content rules relate to the elements and can be associated with specific content types. The content rules can specify what types of content are allowed within types of content, where an element may begin or end, whether an element is associated with another element, etc. For example, a content rule may be associated with tables and specify that a paragraph cannot exist within a table, but a list can exist within a table. In this example, if a table includes a body of text, the paragraph model may generate a relatively high confidence score that the body of text within the table is a paragraph and the list model may generate a relatively high confidence score that the body of text within the table is a list. If the two confidence scores (i.e., that of the paragraph model and the list model) are similarly high, the system can reconcile these similarly high confidence scores based on the content rule that a paragraph cannot exist with a table to determine that the body of text within the table is a list (as opposed to a paragraph). As another example, a content rule associated with images may specify that no other content type can exist within an image (i.e., an image cannot have a nested element with a content type).

In addition to content rules associated with the types of content that may exist in certain scenarios, the content rules can also aid the system in determining the boundaries of an element or the associations between elements. In some embodiments, the content rules can be based on one or more of text characteristics, font properties, spacing, highlighting, etc. For example, if the characters in the document 102 have been recognized (e.g., via optical character recognition (OCR)), the capitalization of the characters can be used in the generation of bounding boxes. As on example, if the first word of an element begins with a capital letter, a new bounding box can be generated. However, if the first word of an element begins with a lower-case letter, that element is assumed to be part of the element of the previous bounding box. Similarly, the system can use indentations (e.g., white space) to determine the beginnings, and endings, of elements. For example, if an element starts with an indentation, the system can determine that the line is part of a new paragraph. Similarly, if a line ends with white space, the system can determine that the line is the end of a paragraph.

As previously alluded to, in some embodiments, the models generate bounding boxes for the elements. The bounding boxes define the limits of each of the elements. For example, as depicted in FIG. 1, the image 126 is bounded by the sixteenth bounding box 128. In one embodiment, each of the models generates bounding boxes for each of the elements of the document 102. Continuing the example provided above, the image model, paragraph model, and list model analyze the image 126 to generate bounding boxes for the image 126. Assuming that the image model generates the highest confidence score for the image 126, the bounding box 128 generated by the image model is the bounding box used for the image 126. Though depicted as rectangular in FIG. 1, the shape of the bounding boxes is not so limited. That is, the bounding boxes can take any suitable polygonal shapes (e.g., triangles, rectangles, pentagons, hexagons, etc.) and/or nonpolygonal shapes.

Once the system has determined the types of the elements and the boundaries for the elements, the system determines a reading order for the document 102. The reading order is the sequence in which the elements of the document 102 will be presented (e.g., to a user utilizing an assistive technology). In one embodiment, a reading order model is used to determine the reading order for the document. For example, the reading order model can be a trained machine learning model. The reading order model can determine the reading order based on the content type of each element, a location of each element in the document 102, the bounding boxes of each element, etc. For example, the reading order model can determine a default reading order based on a left-to-right and top-to-bottom sequence. In the example document provided in FIG. 1, the publication logo 106 is assigned the first reading order and is the top leftmost element in the document 102. In some embodiments, the reading order model can deviate from the default reading order based on additional information about the elements. For example, as depicted in FIG. 1, the reading order proceeds from the first paragraph 134 to the second paragraph 138. The sequence from the first paragraph 134 to the second paragraph 138, however, does not follow a strict left-to-right and top-to-bottom sequence. Instead, the reading order model has determined, based on the content type of the first paragraph 134, the second paragraph 138, and the content below the first paragraph 134 (i.e., the first author name, first author email address, second author name 158, and the second author email address 154) that the elements immediately below the first paragraph 134 should not be the next elements for the reading order. In some embodiments, the content reading order model can also use the content rules to determine reading order. Continuing the discussion of the reading order flowing from the first paragraph 134 to the second paragraph 138, the second paragraph 138 does not begin with an indentation. Accordingly, the reading order model can determine that the second paragraph 138 is a continuation of the first paragraph 134 and should therefore be the next element in the sequence after the first paragraph 134.

The view of the document 102 depicted in FIG. 1 includes the markers 154 and other content indicia (e.g., the bounding boxes) after the document 102 has been processed. Accordingly, each of the elements includes a marker 154 content indicia. With respect to the markers 154, the publication logo's 106 marker is I.1 indicating that the element associated with the publication logo is an image in the document 102 and is the first element in the reading order, the heading associated with the publication 108 includes a marker H1.2 indicating that the heading associated with the publication 108 is the a heading in the document 102 at a first heading hierarchy and is the second element in the reading order, the copyright notice's 112 marker is P.3 indicating that the element associated with the copyright notice 112 is a paragraph in the document 102 and is the third element in the reading order, the title's 116 marker is H2.4 indicating that the element associated with the title 116 is a heading in the document 102 at a second heading hierarchy and is the fourth element in the reading order, the first author photo's 120 marker is I.5 indicating that the element associated with the first author photo 120 is an image in the document 102 and is the fifth element in the reading order, the second author photo's 124 marker is I.6 indicating that the element associated with the second author photo 124 is an image in the document 102 and is then sixth element in the reading order, the image's 126 marker is I.7 indicating that the element associated with the image 126 is an image in the document 102 and is the seventh element in the reading order, the authorship indicator's 130 marker is C.8 indicating that the element associated with the authorship indicator is a caption and is the eighth element in the reading order, the first paragraph's 134 marker is P.9 indicating that the element associated with the first paragraph 134 is a paragraph in the document 102 and is the ninth element in the reading order, the second paragraph's 138 marker is P.10 indicating that the second paragraph 138 is a paragraph in the document 102 and is the tenth element in the reading order, the section header's 140 marker is H2.11 indicating that the element associated with the second header 140 is a heading in the document 102 at the second hierarchy and is the eleventh element in the reading order, the third paragraph's 146 marker is P.12 indicating that the element associated with the third paragraph 146 is a paragraph in the document 102 and twelfth in the reading order, the first author biography's marker is P.13 indicating that the element associated with the first author's biography is a paragraph in the document 102 and is the thirteenth element in the reading order, the first author's email addresses' marker is L.14 indicating that the element associated with the first author's email address is a link in the document 102 and the fourteenth element in the reading order, the second author biography's 152 marker is P.15 indicating that the element associated with the second author biography 152 is a paragraph in the document 102 and is the fifteenth element in the reading order, and the second author's email address' 158 marker is L.16 indicating that the element associated with the second author's email address is a link in the document and is the sixteenth element in the reading order.

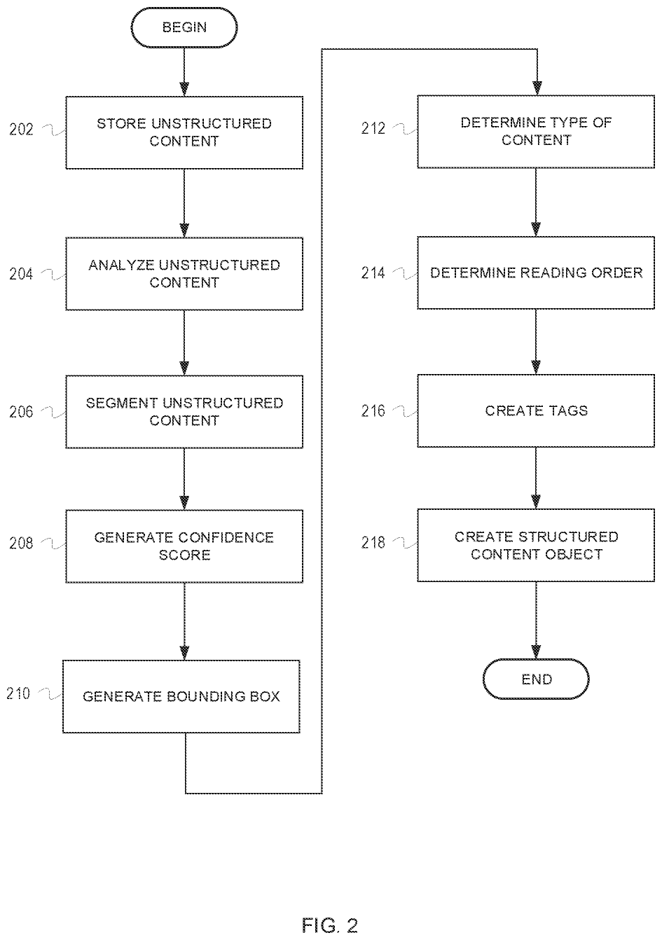

While the discussion of FIG. 1 provides an overview of processing a document (i.e., unstructured content) to create a structured content object, the discussion of FIG. 2 provides additional detail regarding the processing of unstructured content to generate a structured content object.

FIG. 2 is a flow chart depicting example operations for creating structured content objects based on unstructured content. The flow begins at block 202.

At block 202, unstructured content is stored. For example, a database can store the unstructured content. The unstructured content is stored as a datafile. For example, the unstructured content can be a document stored as a datafile in the database. Though the example document described herein is an article, embodiments are not so limited. For example, the document could be a spreadsheet, a report, a presentation, a fillable form, a dataset, etc. The content is unstructured in that it includes little, if any, data that describes, or otherwise defines, the document. The flow continues at block 204.

At block 204, the unstructured content is analyzed. For example, a control system can analyze the unstructured content. In one embodiment, the control system analyzes the unstructured content via a plurality of models. The models can be trained for one or more different types of content. For example, the models can be trained machine learning models that are associated with one, or more, types of content. The flow continues at block 206.

At block 206, the unstructured content is segmented. For example, the control system can segment the unstructured content into a plurality of elements. In one embodiment, the control system segments the unstructured content via the plurality of models. Each of the elements includes a portion of the unstructured content. In some embodiments, the control circuit can perform additional division of the unstructured content during, or prior to, the segmentation. As one example, the control system can divide the unstructured content into portions (e.g., pages, section, passages, chapters, etc.) before the control system segments the unstructured content into a plurality of elements. In such embodiments, the control system can segment each portion of the unstructured content via the models into a plurality of elements and analyze each of the elements via the plurality of models. The flow continues at block 208.

At block 208, confidence scores are generated. For example, the control system can generate the confidence scores based on the analysis of the unstructured content and/or plurality of elements. In one embodiment, each of the models generates confidence scores for each of the elements. The confidence scores indicate the likelihood that a given element is of a certain type of content. For example, the equation model would generate a confidence score for each of the elements indicating how confident the equation model is that each of the elements is in fact an equation. The flow continues at block 210.

At block 210, bounding boxes are generated. For example, the control system can generate the bounding boxes based on the analysis of the unstructured content and/or the plurality of elements. In one embodiment, each of the models generates bounding boxes for each of the elements. In such embodiments, the control system can generate the bounding boxes during, or after, the segmentation of the unstructured content. In other embodiments, the control system generates the bounding boxes after the generation of the confidence scores. In such embodiments, only the model that has generated the highest confidence score will generate a bounding box for a particular element. The bounding boxes indicate the boundaries of the elements. The bounding boxes can be of any suitable shape and are determined based on what each of the models determines the boundaries of the element to be. The flow continues at block 212.

At block 212, a type of content is determined. For example, the control circuit can determine the type of content. In one embodiment, the control system determines the type of the content of each element based on the confidence scores. As a simple example, the control system determines the content type of an element based on which model generated the highest confidence score. For example, if the list model generated the highest confidence score for an element, the control system would determine that element to be a list. In some embodiments, the control system ignores confidence scores below a threshold. For example, if the image model generates a confidence score below the threshold for an element, the control system will assume that the element is not an image. Similarly, if the image model generates a confidence score that is above a threshold, the control system may assume that the element is an image. Additionally, or alternatively, the control system can make content type determinations based on content rules. The content rules relate to the elements and can be associated with specific content types. The content rules can specify what types of content are allowed within or types of content, where an element may begin or end, whether an element is associated with another element, etc. The flow continues at block 214.

At block 214, a reading order is determined. For example, the control system can determine the reading order for the elements. The reading order is the order in which the elements are to be presented (e.g., to a user utilizing an assistive technology). The control system can determine the reading order based on the locations of the elements within the document, the locations of the elements with respect to one another, the content types of the elements, the bounding boxes, the content rules, etc. For example, a default reading order of left-to-right and top-to-bottom can be assumed for the elements. The control circuit can deviate from this default reading order based on relationships between the elements. For example, if a document has multiple columns, the control system can determine that the reading order should proceed from one column to another column, before proceeding further down the page. The flow continues at block 216.

At block 216, tags are created. For example, the control system can create the tags. The control system creates the tags based on the data generated by the models. For example, the control system can create the tags based on the confidence scores, the bounding boxes for each of the elements, the type of content for each of the elements, the reading order for each of the elements, etc. The tags indicate the data for each of the elements. For example, a tag for one of the elements may indicate the confidence score assigned to that element by the model associated with the content type of that element (and possibly one or more of the other models), the bounding box generated by the content type of that element (and possible one or more of the other models), a type of the content for that element, a reading order for that element, etc. In some embodiments, the control system also creates markers, such as those depicted in FIG. 1. For example, the markers can be based on, and include some or all of the content of, the tags. The markers can be inserted into the document as a visualization of the tags. In one embodiment, a user can selectively display and hide the markers. The flow continues at block 218.

At block 218, the structured content object is created. For example, the control system creates the structured content object. In one embodiment, the control system augments the unstructured content with the tags to convert the unstructured content to a structured content object. As one example, if the unstructured content is a Portable Document Format (PDF) file, the control system can create the structured content object by embedding the tags into the PDF file (e.g., as metadata). In such embodiments, the structured content object (i.e., the augmented PDF file) can have both human-readable and machine-readable components. For example, the underlying content (i.e., the document) is a human-readable document and the tags that are embedded in the PDF file are intended as machine-readable content (e.g., for use by an assistive technology processing the PDF file). It should be noted, however, that in some embodiments, the underlying content can be augmented with human-readable markers that indicate the contents of the tags. As another example, the control system can create the structured content object by generating a new technical object that can be used in conjunction with the unstructured content (i.e., converting the unstructured content to a structured content object as a new file). For example, in one embodiment, the control system generates a JavaScript Object Notation (JSON) object based on the tags. The JSON object can then be used in concert with the unstructured data by another computer system to process the unstructured content. For example, a computer system could use the unstructured content and the technical object to create a datafile of another type (e.g., a hypertext markup language (HTML) file) based on the unstructured content and the technical object. In this manner, the technical object can be thought of as a standardized data format that can be used to provide any output desired from the unstructured content.

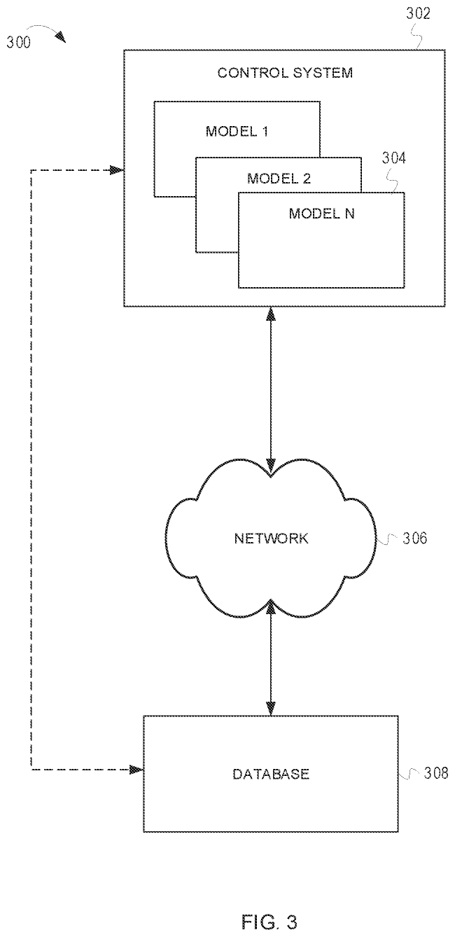

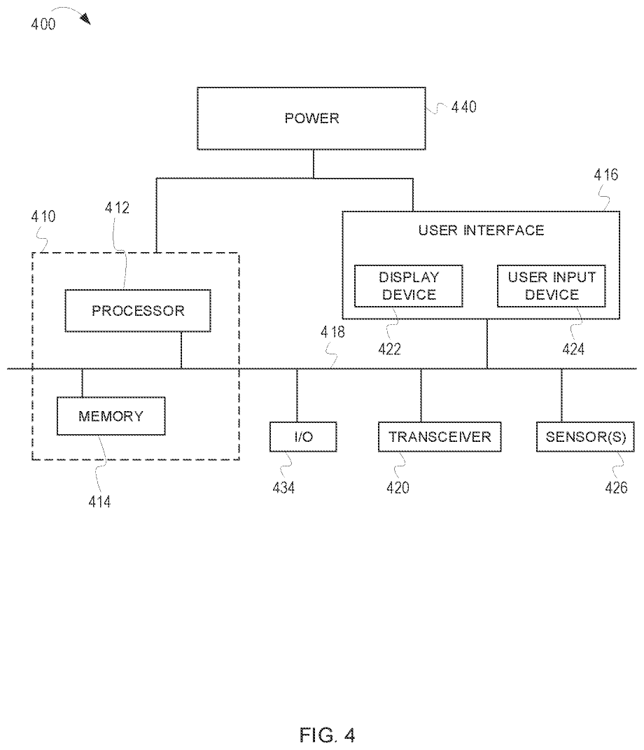

While the discussion of FIG. 2 provides an overview of a system for processing unstructured content to generate a structured content object, the discussion of FIGS. 3 and 4 provides additional detail regarding a system for processing unstructured content to generate a structured content object.

FIG. 3 is a block diagram of a system 300 for creating structured content objects from unstructured content. The system 300 includes a control system 302, a network 306, and a database 308. In one embodiment, the control system 302 is communicatively coupled to the database 308 via the network 306. In such embodiments, the network 306 can be of any suitable type. For example, the network 306 can be a local area network (LAN) and/or wide area network (WAN), such as the Internet. Accordingly, the network 306 can include wired and/or wireless links. In embodiments in which the control system 302 is remote from the database 308, the control system 302 can operate in a cloud-based environment. In such embodiments, the control system 302 can retrieve documents from the database 308 via the network 306 and generate structured content objects to be returned to the database 308 (or some other destination). However, as indicated by the dashed line, in some embodiments, the control system 302 and the database 308 can be local to one another and communicate directly with one another. For example, the control system 302 can be resident on a user device (e.g., a desktop computer, a laptop computer, a tablet computer, a smartphone, a personal digital assistant (PDA), etc.) and the database 308 can be resident in a memory of the user device. Similarly, the database could be resident in a memory that is not on the user device, but rather is external to the user device (e.g., an external memory device). In such embodiments, the control system 302 may process unstructured data before storing a structured content object in the database or transmitting the structured content object elsewhere (e.g., for publication).

The database 308 is configured to store unstructured content. The unstructured content can be associated with any type of electronic file. For example, the unstructured content can be associated with an article, a document, a spreadsheet, an image, etc. The content is unstructured in that it does not have any, or has minimal, data describing the document. For example, the unstructured content may not have any indication of types of content or reading order associated with the content.

The control system 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control system 302 is configured (for example, by using corresponding programming as will be well understood by those skilled in the art) to carry out one or more of the steps, actions, and/or functions described herein.

By one optional approach the control system 302 operably couples to a memory. The memory may be integral to the control system 302 or can be physically discrete (in whole or in part) from the control system 302 as desired. This memory can also be local with respect to the control system 302 (where, for example, both share a common circuit board, chassis, power supply, and/or housing) or can be partially or wholly remote with respect to the control system 302 (where, for example, the memory is physically located in another facility, metropolitan area, or even country as compared to the control system 302).

This memory can serve, for example, to non-transitorily store the computer instructions that, when executed by the control system 302, cause the control system 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control system 302 generally operates to create a structured content object based on the unstructured content. The structured content object includes tags. The tags indicate information about elements of the unstructured content, such as confidence scores, bounding boxes, types of content, reading order, etc. The structured content object can be human-readable and/or machine-readable. For example, in one embodiment, the structured content object can be the document depicted in FIG. 1, in which an original document has been augmented to include indicia based on the tags. As another example, the structured content object can include the tags as data embedded in a file associated with the document (e.g., as metadata). In such embodiments, an assistive technology can utilize the tags to read data associated with the structured content object (e.g., a document).

The control system 302 processes the unstructured content using a plurality of models 304. The control system 302 can include any desired number of models 304, as indicated in FIG. 3. In some embodiments, each of the models is trained for a specific content type. For example, a first of the models 304 can be trained for paragraph recognition, a second of the models 304 can be trained for list recognition, a third of the model 304 can be trained for table recognition, etc. The models analyze each of the elements in the unstructured content to determine characteristics of the elements. For example, the models can analyze each of the elements to determine confidence scores, bounding boxes, and content types for each of the elements. The system 300 generates tags that indicate the characteristics of the elements.

FIG. 4 is a block diagram of a system 400 that may be used for implementing any of the components, circuits, circuitry, systems, functionality, apparatuses, processes, or devices of the system 300 of FIG. 3, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 400 may be used to implement some or all of the control system, the database, the input systems, and/or other such components, circuitry, functionality and/or devices. However, the use of the system 400 or any portion thereof is certainly not required.

By way of example, the system 400 may comprise a processor (e.g., a control system) 412, memory 414, and one or more communication links, paths, buses or the like 418. Some embodiments may include one or more user interfaces 416, and/or one or more internal and/or external power sources or supplies 440. The processor 412 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 412 can be part of control circuitry and/or a control system 410, which may be implemented through one or more processors with access to one or more memory 414 that can store commands, instructions, code and the like that is implemented by the control circuit and/or processors to implement intended functionality. In some applications, the control circuit and/or memory may be distributed over a communications network (e.g., LAN, WAN, the Internet) providing distributed and/or redundant processing and functionality. Again, the system 400 may be used to implement one or more of the above or below, or parts of, components, circuits, systems, processes and the like.

The user interface 416 can allow a user to interact with the system 400 and receive information through the system. In some instances, the user interface 416 includes a display device 422 and/or one or more user input device 424, such as buttons, touch screen, track ball, keyboard, mouse, etc., which can be part of or wired or wirelessly coupled with the system 400. Typically, the system 400 further includes one or more communication interfaces, ports, transceivers 420 and the like allowing the system 400 to communicate over a communication bus, a distributed computer and/or communication network (e.g., a local area network (LAN), wide area network (WAN) such as the Internet, etc.), communication link 418, other networks or communication channels with other devices and/or other such communications or combination of two or more of such communication methods. Further the transceiver 420 can be configured for wired, wireless, optical, fiber optical cable, satellite, or other such communication configurations or combinations of two or more of such communications. Some embodiments include one or more input/output (I/O) ports 434 that allow one or more devices to couple with the system 400. The I/O ports can be substantially any relevant port or combinations of ports, such as but not limited to USB, Ethernet, or other such ports. The I/O interface 434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 426 to provide information to the system and/or sensor information that is communicated to another component, such as the central control system, a delivery vehicle, etc. The sensors 426 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 400 comprises an example of a control and/or processor-based system with the processor 412. Again, the processor 412 can be implemented through one or more processors, controllers, central processing units, logic, software and the like. Further, in some implementations the processor 412 may provide multiprocessor functionality.

The memory 414, which can be accessed by the processor 412, typically includes one or more processor-readable and/or computer-readable media accessed by at least the control circuit, and can include volatile and/or nonvolatile media, such as RAM, ROM, EEPROM, flash memory and/or other memory technology. Further, the memory 414 is shown as internal to the control system 410; however, the memory 414 can be internal, external or a combination of internal and external memory. Similarly, some, or all, of the memory 414 can be internal, external or a combination of internal and external memory of the processor 412. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 414 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

In some embodiments, a system for creating a structured content object based on unstructured content comprises a database, wherein the database is configured to store the unstructured content, and a control system communicatively coupled to the database, wherein the control system is configured to segment the unstructured content into a plurality of elements, analyze, via a plurality of models, each of the plurality of elements, wherein each of the models is trained for a different type of content, generate, by each of the plurality of models for each of the plurality of elements, confidence scores, generate, by each of the plurality of models for each of the plurality of elements, bounding boxes, determine, based on the confidence scores for each of the plurality of elements, a type of content, determine, for each of the plurality of elements, a reading order, create, based on the confidence scores for each of each of the plurality of elements, the bounding boxes for each of the plurality of elements, and the types of content for each of the plurality of elements, tags, wherein the tags include (i) the confidence scores, (ii) the bounding boxes, and (iii) the types of content for each element of the plurality of elements, and create, based on the tags, the structured content object.

In some embodiments, an apparatus and a corresponding method performed by the apparatus comprises storing, in a database, the unstructured content, segmenting, by a control system, the unstructured content into a plurality of elements, analyzing, by the control system via a plurality of models, the plurality of elements, wherein each of the models is trained for a different type of content, generating, by the control system via each of the plurality of models for each of the plurality of elements, confidence scores, generating, by the control system via each of the plurality of models for each of the plurality of elements, bounding boxes, determining, by the control system based on the confidence scores for each of the plurality of elements, types of content, determining, by the control system for each of the plurality of elements, a reading order, creating, by the control system based on the confidence scores for each of the plurality of elements, the bounding boxes for each of the plurality of elements, and the types of content for each of the plurality of elements, tags, wherein the tags indicate (i) the confidence scores, (ii) the bounding boxes, and (iii) the types of content for each element of the plurality of elements, and creating, by the control system based on the tags, the structured content object.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

What is claimed is:

1. A system for creating a structured content object based on unstructured content, the system comprising;
a database, wherein the database is configured to store the unstructured content; and
a control system communicatively coupled to the database, wherein the control system is configured to:
analyze, via a plurality of models, the unstructured content, wherein each of the models is trained for a different type of content;
segment, via the plurality of models, the unstructured content into a plurality or elements;
generate, by each of the plurality of models for each of the plurality of elements, confidence scores;
generate, by each of the plurality of models for each of the plurality of elements, bounding boxes;
determine, based on the confidence scores for each of the plurality of elements, types of content;
determine, for each of the plurality of elements, a reading order;
create, based on the confidence scores for each of the plurality of elements, the bounding boxes for each of the plurality of elements, and the types of content for each of the plurality of elements, tags, wherein the tags indicate (i) the confidence scores, (ii) the bounding boxes, and (iii) the types of content for each element of the plurality of elements; and
create, based on the tags, the structured content object.

2. The system of claim 1, wherein each of the plurality of models is a trained machine learning model.

3. The system of claim 1, wherein the type of content is one or more of an equation, a list, a table, an image, a paragraph, and a heading.

4. The system of claim 1, wherein the unstructured content is based on a human-readable document, and wherein the control system is further configured to:
augment, based on the tags, the human-readable document to include indicators of one or more of the bounding box, the type of content, and the reading order for each of the plurality of elements.

5. The system of claim 1, wherein the structured content object is a JavaScript Object Notation (JSON) object.

6. The system of claim 1, wherein the control system is further configured to:
apply, to each element of the plurality of elements, content rules, wherein the content rules are associated with the different content types;
wherein the control system one or more of determines the type of content for each of the plurality of elements and generates the bounding box for each of the plurality of elements based on the content rules.

7. The system of claim 1, wherein the structured content object is machine-readable.

8. The system of claim 1, wherein the control system is further configured to:
generate, based on the structured content object, a machine-readable document.

9. The system of claim 1, wherein the structured content object is based on an accessibility standard.

10. The system of claim 1, wherein the determination of the type of content is based on a threshold.

11. A method for creating a structured content object based on unstructured content, the method comprising:
storing, in a database, the unstructured content;
analyzing, by a control system via a plurality of models, the unstructured content, wherein each of the models is trained for a different type of content;
segmenting, by the control system via each of the plurality of models, the unstructured content into a plurality of elements;
generating, by the control system via each of the plurality of models for each of the plurality of elements, confidence scores;
generating, by the control system via each of the plurality of models for each of the plurality of elements, bounding boxes;
determining, by the control system based on the confidence scores for each of the plurality of elements, type of contents;
determining, by the control system for each of the plurality of elements, a reading order;
creating, by the control system based on the confidence scores for each of the plurality of elements, the bounding boxes for each of the plurality of elements, and the types of content for each of the plurality of elements, tags, wherein the tags indicate (i) the confidence scores, (ii) the bounding boxes, and (iii) the types of content for each element of the plurality of elements; and
creating, by the control system based on the tags, the structured content object.

12. The method of claim 11, wherein each of the plurality of models is a trained machine learning model.

13. The method of claim 11, wherein the type of content is one or more of an equation, a list, a table, an image, a paragraph, and a heading.

14. The method of claim 11, wherein the unstructured content is based on a human-readable document, the method further comprising:
augmenting, by the control system based on the tags, the human-readable document to include indicators of one or more of the bounding box, the type of the content, and the reading order for each of the plurality of elements.

15. The method of claim 11, wherein the structured content object is a JavaScript Object Notation (JSON) object.

16. The method of claim 11, further comprising:
applying, to each element of the plurality of elements, content rules, wherein the content rules are associated with the different content types;
wherein one or more of the determining the type of content for each of the plurality of elements and generating the bounding box for each of the plurality of elements is based on the content rules.

17. The method of claim 11, wherein the structured content object is machine-readable.

18. The method of claim 11, further comprising:
generating, by the control system based on the structured content object, a machine-readable document.

19. The method of claim 11, wherein the structured content object is based on an accessibility standard.

20. The method of claim 11, wherein the determination of the type of content is based on a threshold.
